(19) United States
(12) Patent Application Publication
(10) Pub. No.: US 2005/0269009 A1
(43) Pub. Date: Dec. 8, 2005

(54) Method and apparatus for forming a core of plies, belts and beads and for positioning the core in a mold for forming an elastomeric tire and the formed elastomeric tire

(76) Inventors: Richard A. Steinke, Boulder City, NV (US); Theodore M. Love, Las Vegas, NV (US)

Correspondence Address: M. REID RUSSELL, 854 WEST 3390 SOUTH, HURRICANE, UT, 84737, US

(21) Appl. No.: 10/860,997

(22) Filed: Jun. 4, 2004

(51) Int. Cl. B29D 30/00

(52) U.S. Cl. 152/531; 156/117; 156/130; 152/452; 152/548; 152/532; 156/397; 264/279; 264/310; 425/35

(57) ABSTRACT

A method and apparatus for forming a core of plies, belts and beads and for positioning the core in a mold for forming an elastomeric tire. The core is built up on a mandrel of the inner mold formed by hard foam core segments that are positioned on a bottom hub plate and around a hub fitted to the center of the bottom hub plate, and with a top hub plate fitted thereover in alignment with flow passages formed therethrough. Plies are first wound on a porous spacer, across the mandrel and the ply ends are folded around a tire bead and back upon themselves. Woven belt segments that form a belt whose cords form an angle of approximately twenty four degrees to the circumference and slope oppositely, are wound over a spacer wrap that has been applied over the plies outer circumference, and tire cord is wrapped over an outer spacer wrap. The inner mold and core are fitted in an outer mold and the assembly positioned in a casting well to receive a flow of an elastomeric material directed therein as the mold is spun up.

### BACKGROUND OF INVENTION

1. Field of the Invention

This invention pertains to methods and apparatus for forming a core containing belts, plies and beads for positioning in a spin casting mold to receive a flow of an elastomeric material passed therein, forming a transport tire and the tire formed by this method and with this apparatus.

2. Prior Art

The present invention is in a new and unique process and apparatus for the formation of a core of belts, plies and beads, and its positioning in a spin casting mold to form an elastomeric tire. The belts, plies and beads are maintained as a core for encapsulation in a tire that is formed from an elastomeric material, preferably in a spin casting process. The core is formed on an inner mold that is coupled with an outer mold, with the finished mold containing the core to receive a flow of an elastomeric material therearound that is passed through spacers to meld with the material of the plies and belts, spacing them apart in a finished tire. The elastomeric material flow consists of component chemicals that are combined and react, providing an exothermic reaction generating heat and form a finished tire. Where, heretofore in earlier tire forming processes, workers sequentially positioned, and bonded together with adhesives, layers of green rubber and fabric around a mandrel, building a tire from the inside out. Which process includes encapsulating beads in the wide wall ends, with the assembly then cooked or vulcanized, under heat and pressure, in a mold, forming a tire. Additionally, while some art exists showing a attempts at molding tires utilizing elastomeric compounds other than rubber, such have not provided the for building a core of plies, belts and beads on an inner mold section of the shape of a finished tire interior, have not provided for weaving the plies on the mold in one embodiment and the plies and belts in another embodiment, and have not included porous spacers to allow uniform flow of the elastomeric material throughout the mold in the casting process as does the invention. Examples of such earlier patents that do not involve the above steps and the apparatus for their practice of the invention are set out in U.S. patents to Maynard, U.S. Pat. No. 2,476,884; to Cadwell et al., U.S. Pat. No. 2,873,790 and to Cesar, et al., U.S. Pat. No. 4,476,908: and in a British Patent to Merriman, et al., U.S. Pat. No. 1,246,471.

Unique to the invention is a formation of a core of belts plies and beads in sequential steps on an inner mold, and its positioning in an outer mold, with the completed mold to receive a flow of elastomer directed therearound in a spin casting process. In which core formation, a liquid pre-cured elastomer is used to maintain the ends of plies folded over the beads where the exothermic heat of reaction of the combined chemicals that form the elastomer provides for a final curing of such pre-cured elastomer. In forming the core on the inner mold fabric cords, such as rayon or cotton cords, are woven onto the inner mold as plies that extend around the tire and have the plies ends folded around each of a pair of beads and back upon themselves and are held in place as with a pre-cured elastomer. Belts formed across the plies outer surface as weaves of rayon or cotton cord that have a crossing angle of approximately twenty four degrees, and are maintained over the plies circumference, and including porous spacers fitted between which layers of plies and belts, forming a sandwich that will become the tire core of belts, plies and beads to receive an elastomer injected or other wise passed into the mold, flowing therearound and encapsulating the core. Which molding process is preferably a spin casting process where the elastomer components are sprayed into the mold and react together. Heat is produced in an exothermic reaction provided by the elastomer components being mixed together that finishes the curing of the pre-cure elastomer, providing a homogenous mixture of cured elastomer.

The method and apparatus of the invention, while requiring significant labor to form the core, constitutes a major improvement to the tire industry in that it makes possible the first practical manufacture of a balanced transport tire from an elastomer, notably urethane, that has been approved by the U.S. Department of Transportation for manufacture and sale to the public as a transport tire. This approval opens the door for the development of more automated methods to produce the core like that set out herein, producing a transport tire that will be far easier and cheaper to construct than is possible with tire technology and materials as have heretofore been commonly used. Prior to the present method one of the present inventors was an inventor of a U.S. patent application for a Tire Core Package for Use in manufacturing a “Tire with Belts, plies and Beads and Process of Tire Manufacture” Ser. No. 10/143,678, files May 13, 2002, that is presently pending, that sets out a process for forming, utilizing a sandwich of pre-cured elastomer between layers of plies and belts formed over a mandrel for fitting into a mold, preferably a spin casting mold. This procedure, though practical, was not used in the manufacture of the elastomeric tire as was approved by the U.S. Department of Transportation, the is the subject of the present application. Which present process and apparatus for its practice is believed to be new and unique. Also, one of the inventors of the present application is the sole inventor of a U.S. patent application for a Elastomeric Tire With Arch Shaped Shoulders filed contemporaneously with this application.

### SUMMARY OF THE INVENTION

It is a principal object of the present invention to provide a process and apparatus for forming an elastomeric tire where a tire core is formed on a spin casting inner mold as a core containing plies, belts and beads, with that inner mold connect to an outer mold for receiving a flow of elastomeric material poured therein as the mold is being turned at an optimum speed to uniformly distribute the elastomeric material uniformly throughout the mold, providing for optimum positioning of the plies, belts and beads in a finished tire.

Another object of the present invention is to provide a process for manufacturing an elastomeric tire with a core of plies, belts and beads encapsulated therein in a spin casting process where the plies, belts and beads are built, in sequential steps onto an inner mold that then receives an outer mold shell fitted thereto with the plies, belts and beads positioned in the mold annular portion to receive a flow of liquid elastomeric material passed therein as the mold is spun up, spin casting a tire with the core of plies, belts and beads encapsulated therein.

Another object of the present invention is to provide a process and apparatus for manufacturing an elastomeric tire with a core of plies, belts and bead encapsulated therein utilizing an elastomer that is a mixture of a selected isocyanate and polyol combined to have, when cured, physical properties comparable to those of a conventional transport fire designed for carrying a like load to that of a tire produced by a practice of the process in the apparatus of the invention.

Still another object of the present invention is to provide a process where plies and belts are formed on an inner mold in layers with spacers between the inner mold and plies, and between each layer of plies and belts, and as a last layer on a top belt, that is selected to allow for a flow of elastomeric material therethrough, maintaining separation of the layers of plies and belts in the finished tire.

Still another object of the present invention is to provide a process for forming an elastomeric tire where in a formation of the core the plie cord ends are looped around the tire beads and bonded on themselves as by application of a pre-cured elastomer that fully cures with contact with the elastomeric passed into the mold that at a high temperature due to an exothermic reaction of the elastomer material constituents.

The present invention is in a process for forming a core of plies, belts and beads on an inner mold portion of a mold that, when connected to the outer mold components, provides a center annular cavity that is open to received a flow of liquid elastomeric material as is produced in a mixing of an isocyanate and polyol that is passed into the mold as it is being turned, filling the annular cavity and forming the elastomeric tire with the core of plies, belts and beads encapsulated therein. A mold for practicing the process can be, but need not be, included with the spin casting apparatus like that set out in U.S. Pat. Nos. 4,855,096 and 4,943,323; and 5,906,836, and 6,165,397, that one of the present inventors is a joint inventor of, and improvements thereto. The invention provides a use of an inner mold for the mounting tire plies, belts and beads, or combination thereof, forming a core on that inner mold where, with an outer mold fitted thereto, becomes an annular portion of the finished mold that is to receive a flow of the elastomeric material, for forming, by spin casting, in a single molding operation, a finished elastomeric tire.

The process of the invention involves the sequential steps of assembling and bolting together the internal mold components including: top and bottom hubs, manifold and hard core, with the hard core providing a surface for building the tire core on and includes fitting an axle with hubs through the mold center and with the assembly then moved to a build cradle. Bobbet plates are fitted to the axle, each in engagement with a mold side. A porous ply cushion is fitted around the mold hard core, and ply cord, that is preferably rayon or cotton cord, is wound from side to side, around pins that extend outwardly from the bobbet plates, the cord being looped around the individual pins, forming a tire ply that extends across the hard core circumference and down the side walls, past where a bead will be installed on each side. Spacing material, that is preferably a four layer section of cotton batting, approximately eight inches in width, is fitted around the core circumference, holding the plies in place. Alternatively, in a first embodiment, over a spacer layer, strips of belting that are two sections of belts that are woven oppositely from rayon or cotton cord are fitted around the core circumference, above the plies, such that each belts section crosses one below and above in the around the circumference center, with each belt section cord forms a twenty four (24) degree angle to an inner mold circumference, and with spacers fitted between each belt. With, in a second embodiment, gear plates are installed to the mold sides, against the bobbet plates, and belting cord is laced back and forth between the gear plates outer teeth, with the belt sections cords each forming approximately a twenty four (24) degree angle to a line around the circumference of the inner mold. With subsequent belting sections being laid up on the bias to where the cords are laid up in opposite directions to the cords of the sections above and below.

With the plies and belts installed with spacers, such as the four layer sections of cotton batting, or a like porous material fitted between the layers of plies and belts, a last layer of the cotton cloth batting is fitted over the belts, around the core, and a final layer Kevlar cord is would around the circumference, winding the Kevlar tire cord from one side to the other, across the crown, as the inner mold mounting the core is turned. For the embodiment of the belts formed utilizing the opposing gears, as a final step, the loop ends of the belts are picked off the teeth and a rayon cord is passed through the loop ends of each side of the tire core, as by use of a needle, and the cord is tightened on itself, cinching the belts loop ends against the sides of the plies.

After the gear plates are removed, a bead is installed to each core side by fitting it over the edge of the bobbet plate and securing it thereto, as with a coating of a pre-cured elastomer. The plies loop ends are then pulled off of the bobbet plates pins, and the loose plies loop ends, on each core side, are pulled up over the bead and a needle, threaded with a thin cord is passed through the plies loop ends, and the thread ends tied, forming a loop through the plies ends. After the plies surfaces above each bead are secured together, the bobbet plate is removed, and a mold gate plate is installed thereover, maintaining bead positioning.

With gate plates installed onto each mold side, the hub is removed and the hard core mounting the core of plies, belts and beads, and the outer mold is fitted to the inner mold, completing the mold, that has an open in the center of one mold side wherethrough the elastomer is to be passed. Thereafter, a lifting rod is installed for moving the hard core mounting the core of plies, belts and beads into a casting well that is spun up to a range of 250 to 750 rpm and the elastomeric constituents are mixed and passed into the mold opening, casting a tire.

Still other benefits and advantages of the invention will become apparent to those skilled in the art to which it pertains upon a reading and understanding of the following detailed specification.

### DESCRIPTION OF THE DRAWINGS

The invention may take physical form in certain parts and arrangement of parts, used to practice the steps of the invention and preferred embodiments of which will be described in detail in this specification and illustrated in the accompanying drawings which form a part hereof:

FIG. 1 shows an exploded perspective view taken from above a bottom hub plate whereto a manifold is being fitted with studs turned into the bottom hub plate for forming an inner mold of the apparatus of the invention that is used in a practice of the process of the invention;

FIG. 2A shows the inner mold components of FIG. 1 receiving a pair of hard foam core segments fitted over the studs;

FIG. 2B shows all but a pair of the hard foam core segments assembled to the bottom hub;

FIG. 3A shows the completion of the hard form core segments assembly and with a top hub plate fitted onto the hard form core segments;

FIG. 3B shows the top hub plate being bolted onto the top of the manifold;

FIG. 4A shows the assembly of FIG. 3B as having been rotated ninety degrees and has have an axle fitted through center openings in the top and bottom hub plates, and showing bobbet plates being slid over the axle ends;

FIG. 4B shows the bobbet plates as having been secured onto the surfaces of the top and bottom hub plates and the internal mold as having been lifted, and with the axle ends positioned onto tops of arms of a build cradle;

FIG. 5A shows a one piece ply cushion fitted around the internal mold circumference;

FIG. 5B shows the internal mold mounted in the build cradle of FIG. 5A and shows a spool of rayon or cotton cord representing a continuous cord being laced back and forth between spaced pins that extend at right angles outwardly from around each of the bobbet plates, weaving a ply;

FIG. 5C shows a view like that of FIG. 5C except that the plies are shown as having been formed, and a layer of butting, that is preferably a cotton bunting, has been secured around the outer circumference, followed by belts formed separately as belt sections that are then laid and maintained around the inner mold outer circumference as continuous belts, with each layer separated by a spacing layer, and the belt cords form approximately a twenty four degree angle to a line across the circumference, and cross each other at the center of the circumference;

FIG. 6A shows a side elevation of a tire bead;

FIG. 6B shows an exploded perspective view of the bead of FIG. 6A aligned for fitting into a coating of a pre-cured elastomer that is pressed into a trough in one of a pair of bead alignment trays;

FIG. 6C shows a vessel containing liquid pre-cured elastomer being poured onto the bead of FIGS. 6A and 6B;

FIG. 6D shows the bead of FIGS. 6A, 6B and 6C encapsulated in pre-cured elastomer;

FIG. 6E shows the encapsulated bead of FIG. 6D maintained with a layer of pre-cured elastomer on a section of non-stick material and is being moved into position onto the ply;

FIG. 6F shows the bead and pre-cure coating fixed onto the ply, with the section of non-stick material removed, and showing a section of the ply ends picked of the bobbet plate pins that are then folded across the bead and stuck onto the ply surface;

FIG. 7A shows the core of FIG. 6F after all the plies ends have been pulled off of the bobbet plate pins, and with all the ply cord ends folded across the bead and bonded with pre-cure elastomer onto themselves, and with the bobbet plates having been removed, and showing a Kevlar cap, as a cord dispensed from a roll, being applied onto the ply cushion;

FIG. 7B shows the core of FIG. 7A after the Kevlar cap cords have been would around, to cover, the ply cushion;

FIG. 8A shows the core of FIG. 7B as having had the axle removed and is positioned onto a mold base;

FIG. 8B shows one of the tread segments as are fitted together to form the exterior or outer mold;

FIG. 8C shows the thread segments of FIG. 8B assembled into the mold outer wall;

FIG. 8D shows a top plate installed onto the assembly of FIG. 8C with arrows A indicating the direction of mold spinning, showing a center opening wherethrough the liquid elastomer is poured in a spin casting process and showing a lifting rod centered in which center opening that will be removed after the mold is mounted in a casting well;

FIG. 9A shows an alternative arrangement for forming belts onto the inner mold circumference, above the plies, as including gear plates that are installed onto the core sides, outside of the bobbet plates, and showing, in anticipation of weaving belts over the circumference, a section of cotton batting fitted as a continuous belts around the circumference;

FIG. 9B shows a view like that of FIG. 9A with a spool of cord shown being wound back and forth across and looping around the individual gear plate teeth, forming a belt section where the belt cords form a twenty four degree angle to a horizontal line across the circumference;

FIG. 9C shows a view like that of FIG. 9B showing two belt sections as having been wound between the gear plate teeth, each section formed at a twenty four degree angle to the horizontal line across the circumference, with the two belt sections forming a single belt;

FIG. 9D shows a view like that of FIGS. 9C showing a layer of cotton batting wound around the core circumference whereafter a continuous Kevlar cap is fitted thereover, and showing, with a threaded needle, a cord passed through the belt ends of both sides of the core that is tied at its ends to pull the belt loop ends down the plies, maintaining belt positioning, whereafter the gear plates are removed;

FIG. 9E shows a view like that of FIGS. 9A-9D, showing the gear plates as having been removed and the bead ends pulled down the plies walls, with the bead shown as having been positioned onto ply and showing a removal of a section of ply ends off from the bobbet plate pins that are folded over the bead;

FIG. 9F shows a view like that of FIG. 9E only showing all the ply ends removed off from the bobbet plate pins, folded over the bead and secured to the ply cords, and after the bobbet plate has been removed;

FIG. 10 shows a side elevation exploded sectional view of a section of a tire manufactured manufactured by the process and with the apparatus of the invention;

FIG. 11 shows an assembled view of the tire of FIG. 10.

### DETAILED DESCRIPTION

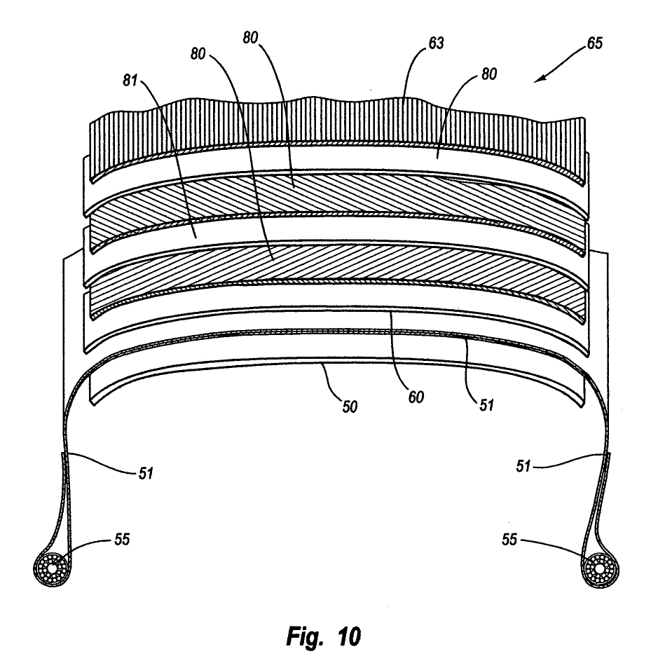

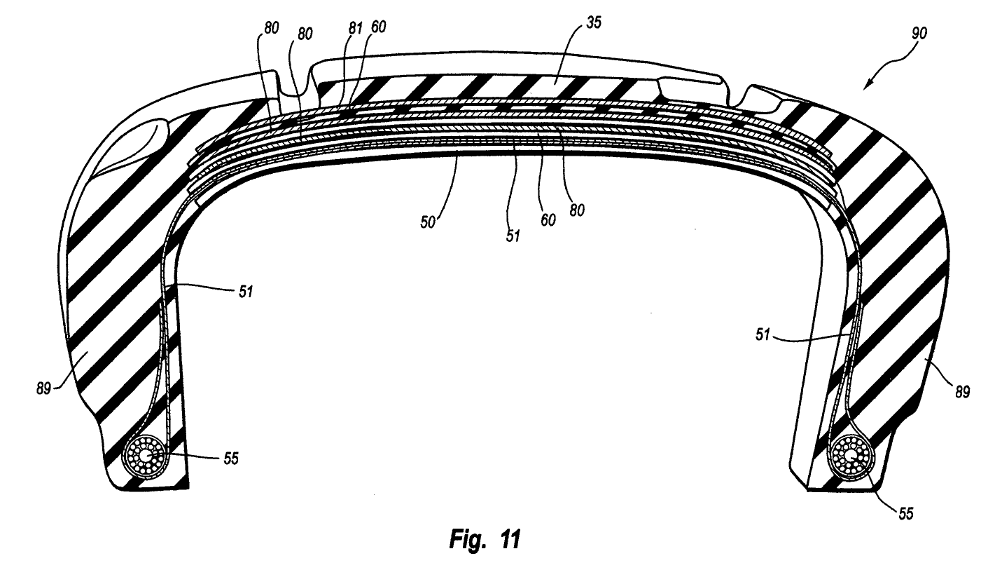

The invention is in a process and apparatus for forming of a tire core within an inner mold of properly positioned plies, belts and beads, closing that inner mold with an outer mold that is to receive a flow of a liquid elastomeric material flow directed therein with the mold spun to form a spin cast tire. In which tire, the core of plies, belts and beads are encapsulated forming a near perfectly balanced tire, with a tire 10 that is like that produced by a practice of the method or process of the invention in apparatus of the invention, shown as a section in FIGS. 10 and 11. Which process and apparatus for forming the tire core of plies, belts and beads and a tire formed by this process are the subject matter of the invention.

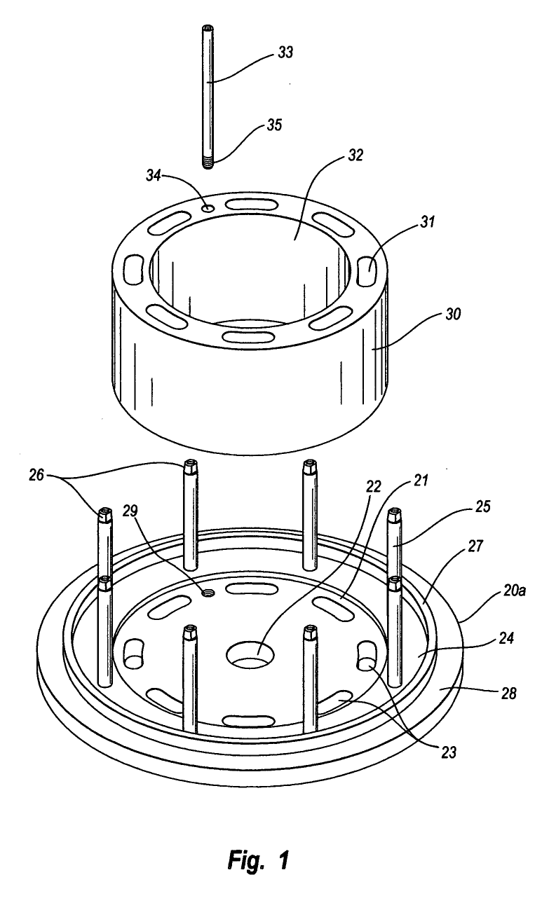

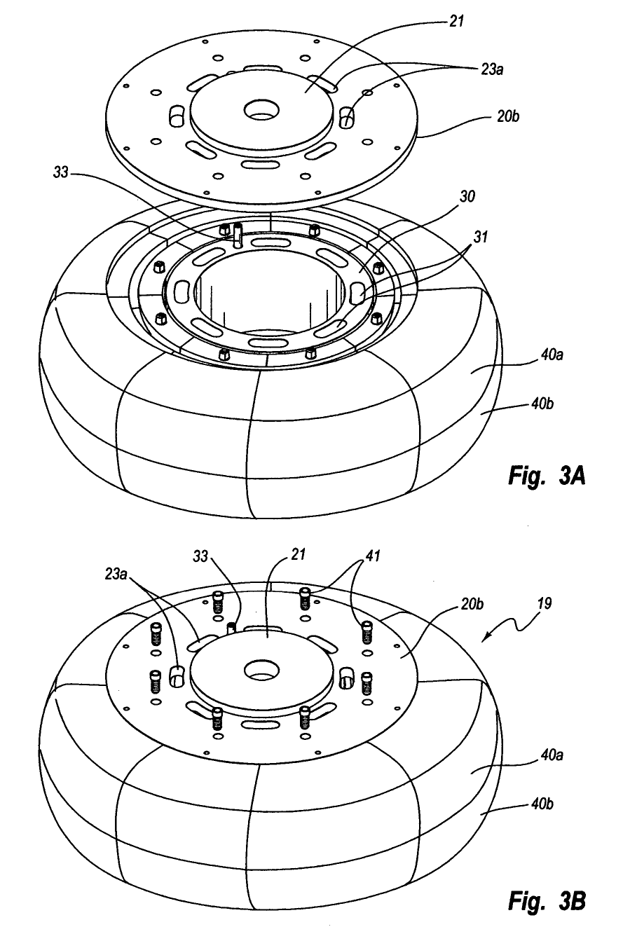

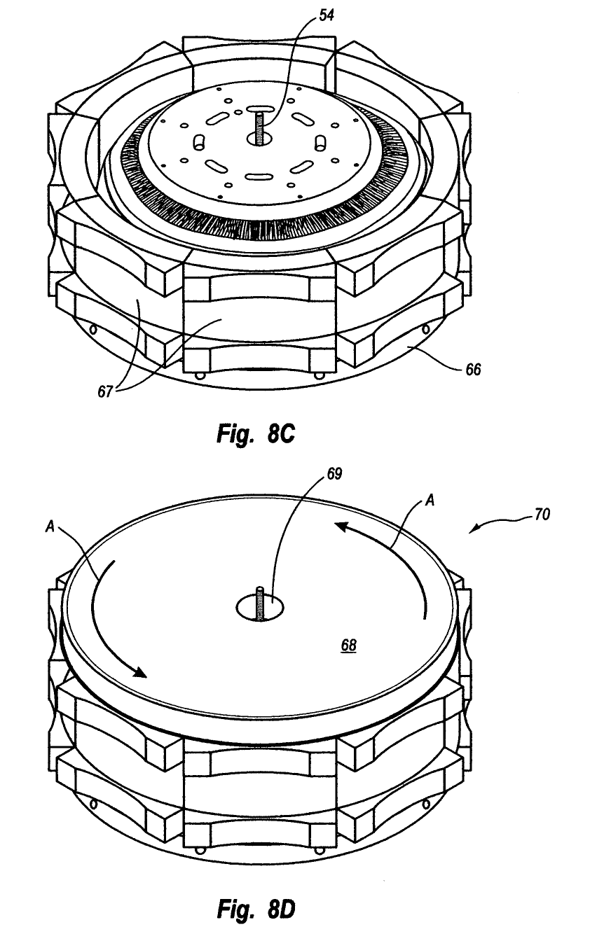

To form the inner mold 19, as shown in FIG. 3B, that a core 65 of plies, belts and beads is formed on, as shown in FIG. 8A, an inner mold hub base 20a, as shown in FIG. 1, is used. The inner mold base 20a is shown as having a center dish 21 that has a center opening 22, includes spaced elliptical ports 23 and is stepped upwardly to a continuous shelf 24 that posts 25 are mounted to extend at right angles and are located at spaced intervals, and each post includes a threaded nut 26 that is secured onto each post end 26a. Outwardly from the posts 25 the hub base 20a is stepped upwardly into a lip 27 and, outwardly from the lip 27, is stepped downwardly into a flat portion 28 that extends to the plate edge. Shown in FIG. 1, a cylindrical hub 30 has its lower end aligned to fit onto the center dish area 21, aligning cylinder spaced elliptical ports 31 with the spaced elliptical ports 23 of the hub base. The cylindrical hub 30 is maintained in position by fitting rod 33 through a side longitudinal hole 34 and turning a rod threaded end 35 into a threaded hole 29 that is formed into a side of the hub base 20a.

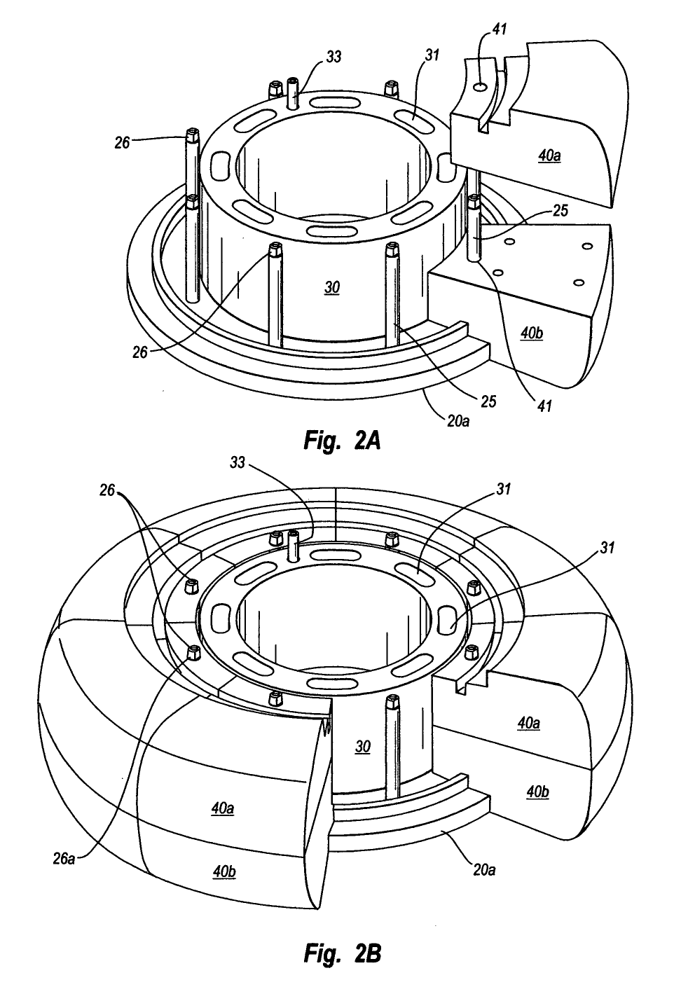

FIG. 2A shows the hub 30 fitted onto the inner mold hub base 20a and maintained thereon by the rod 33 threaded end turned into the hub base threaded hole, and showing hard foam core top and bottom sections 40 and 40b, respectively, being fitted onto the posts 25. With, in FIG. 2B, all but one pair of hard foam core top and bottom sections 40a and 40b have been fitted onto posts 25, and nuts 26 are shown as having been turned onto the post threaded ends 26a.

FIG. 3A shows the top of the hub 30 with the hard foam core top and bottom sections 40a and 40b assembled thereon aligned with a hub top 20b with, it should be understood, the hub base and top, 20a and 20b, respectively, being a mirror image of one another. FIG. 3B shows the hub top 20b fitted onto the top of hub 30, with spaced elliptical ports 23a formed through the hub top 20b aligning with the elliptical ports 21 in hub 30 and the elliptical ports 23 in the hub base 20a, proving flow paths through the assembly, and showing bolts 41 aligned for turning through the hub top 20b and into the nut 26 that have been themselves turned onto the ends 26a of the posts 25, completing the assembly of the inner mold 19.

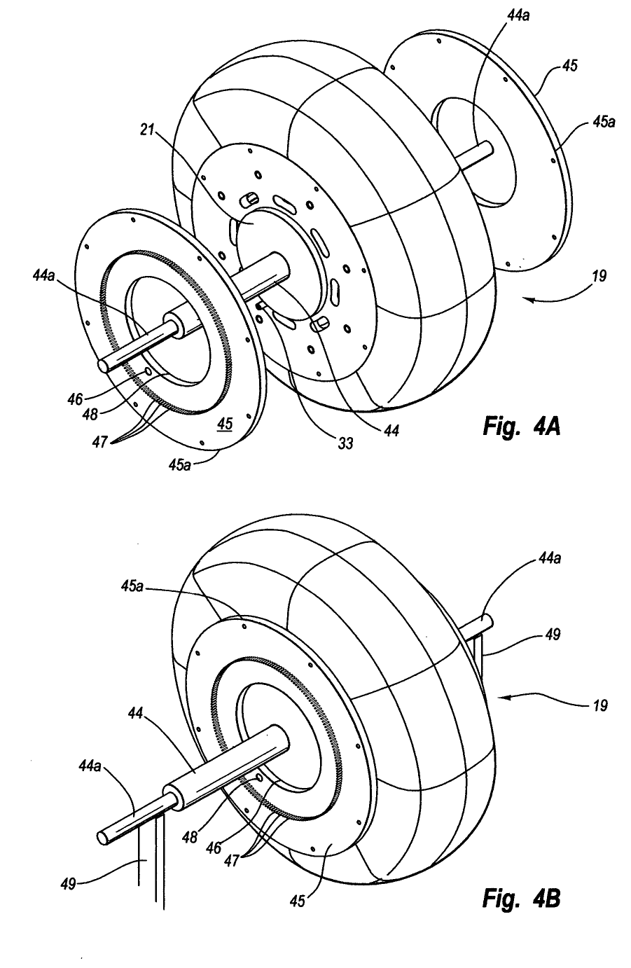

FIG. 4A shows the inner mold as having had an axle 44 mounted through the aligned center openings in the hub base and top 20a and 20b, with the inner mold having been pivoted through ninety degrees, and identical bobbet plates 45 are shown fitted along the axle 44, sliding first over outer axle end 44a. The bobbet plates 45 each include a center opening 46 that is of a diameter to closely fit over each of the hub base and top 20a and 20b, respectively, center dish 21 outer surface. The bobbet plates 45 each have spaced pins 47 formed into a circle, extending at right angles outwardly from the bobbet plate surface, that are spaced outwardly from the center opening 46. To provide proper registry of which bobbet plates 45 onto the hub base and top 20a and 20b, the ends of rods 33 are align with and fitted into holes 48 formed in each bobbet plate. Shown in FIG. 4B the axle ends 44a have been positioned on top ends of vertical arms 49 of a build cradle, allowing the inner mold 19 to be rotated.

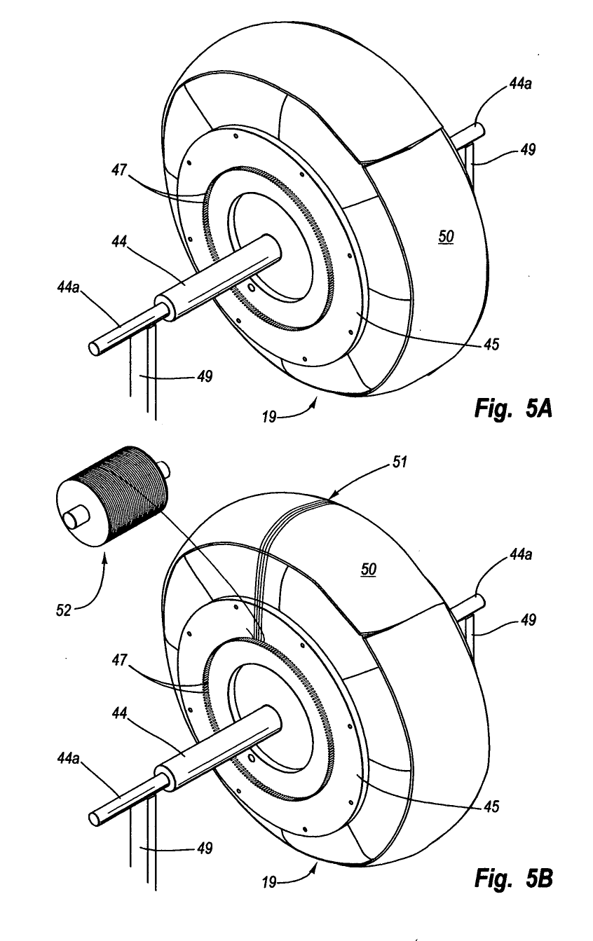

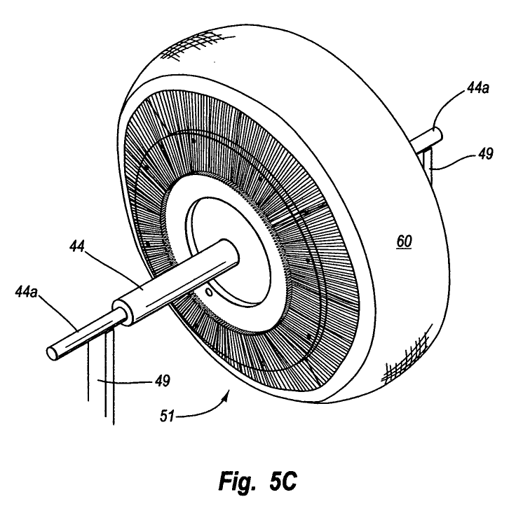

FIG. 5A shows the inner mold 10 that has received a layer of ply foam spacing material 50 wrapped around the mold crown that is coated with an adhesive to bond to the ply cords as they are wound thereon. Shown in FIG. 5B, plies 51 are formed up the inner mold sides and across the crown by looping ply cord around the bobbet plate pins 47, the cord traveling back and forth across the crown. Which cord, for a practice of the invention, is preferably rayon or cotton cord that, in practice, has been found to accept a flow of the elastomeric material into the cord surface, providing a weld of the cord and elastomer that is resistive of separation, and the selected cord is illustrated by a spool 52 that has the selected cord wound thereon. Though, it should be understood the selected cord, in practice, continuous. With, in FIG. 5C, the winding of plies 51 has been completed and the crown is covered with a spacer 50 that is porous to pass liquid elastomer therethrough in the spin casting process. A preferred spacing material is a four layer section of cotton batting that is approximately eight inches wide, and is wound circumferentially around the crown to hold the plies in place.

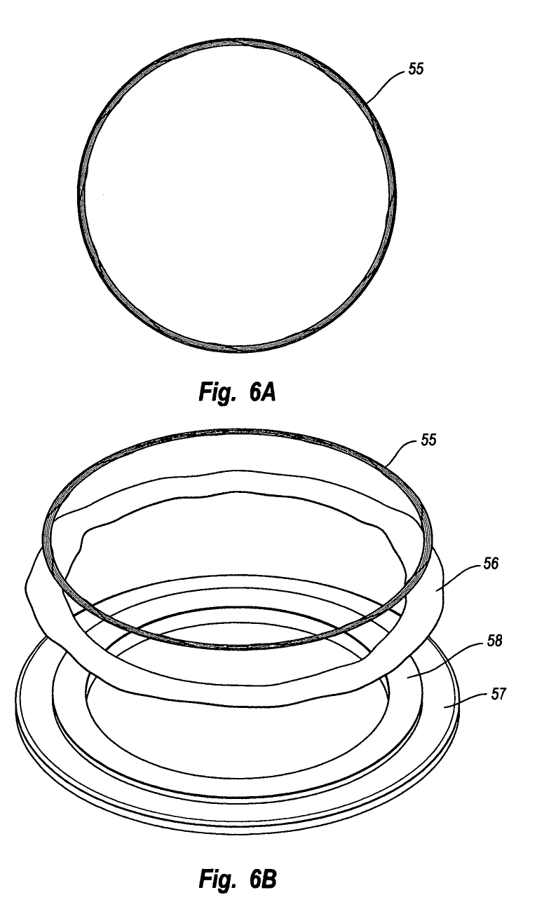

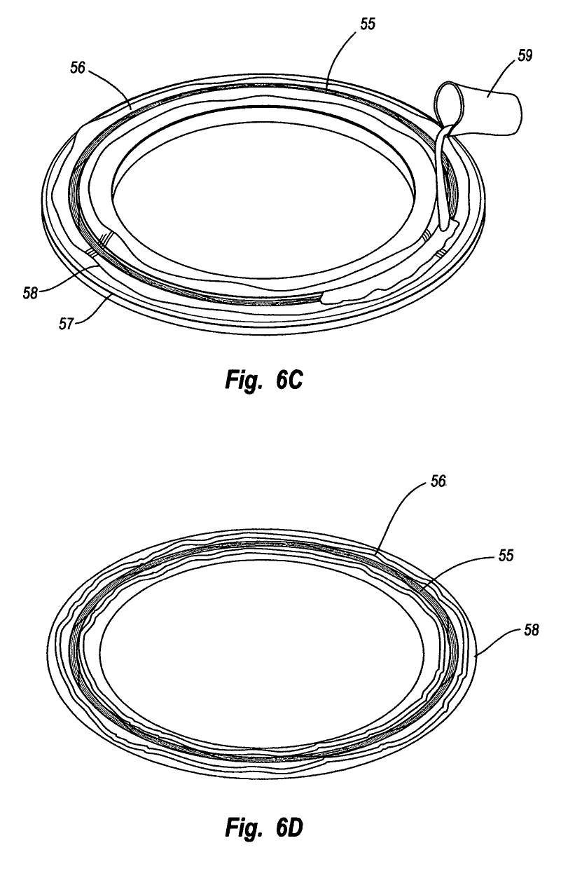

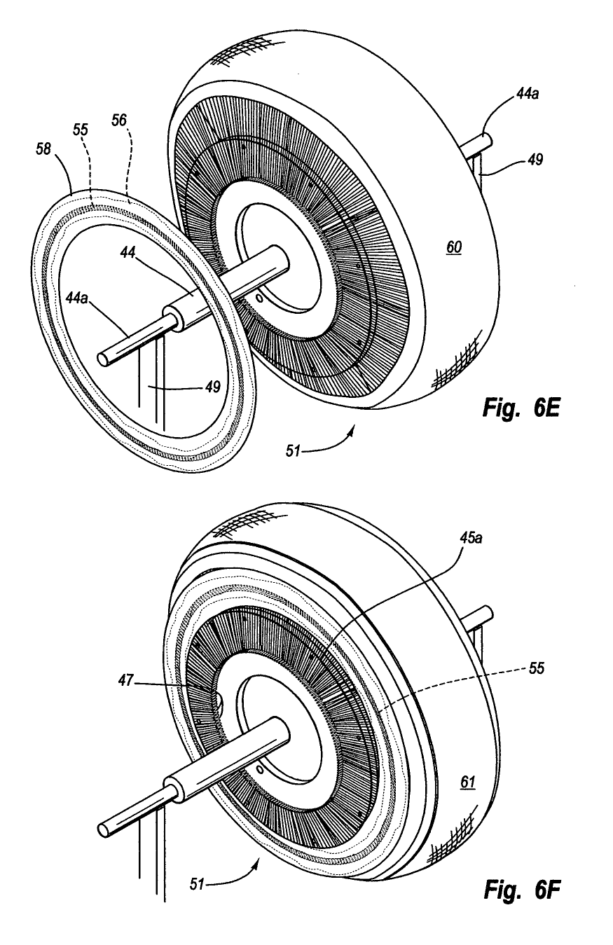

FIG. 6A shows a bead 55 that is formed to be inelastic, preferably from steel, and has a diameter to allow it to just pass by the outside edge 45a of the bobbet plate 45. The bead 55, as shown in FIG. 6B, illustrates a first embodiment of a step for fixing the bead 55 to the plies 51, as set out herein below. The bead 55 is shown in FIG. 6B, aligned with a layer 56 of adhesive material, that is preferably a layer of soft pre-cured elastomer. The bead 55 and layer of pre-cured elastomer are, in turn, aligned with a tray 58 of a bead alignment plate 57. FIG. 6C shows bead 55 and pre-cured elastomer layer 56 positioned in the alignment plate tray 58, and shows a second layer of pre-cured elastomer being poured thereon from cup 59. FIG. 6D shows the bead 55 coated with pre-cured elastomer 56 in preparation for it being slid over the outside edge 45a of the bobbet plate 45.

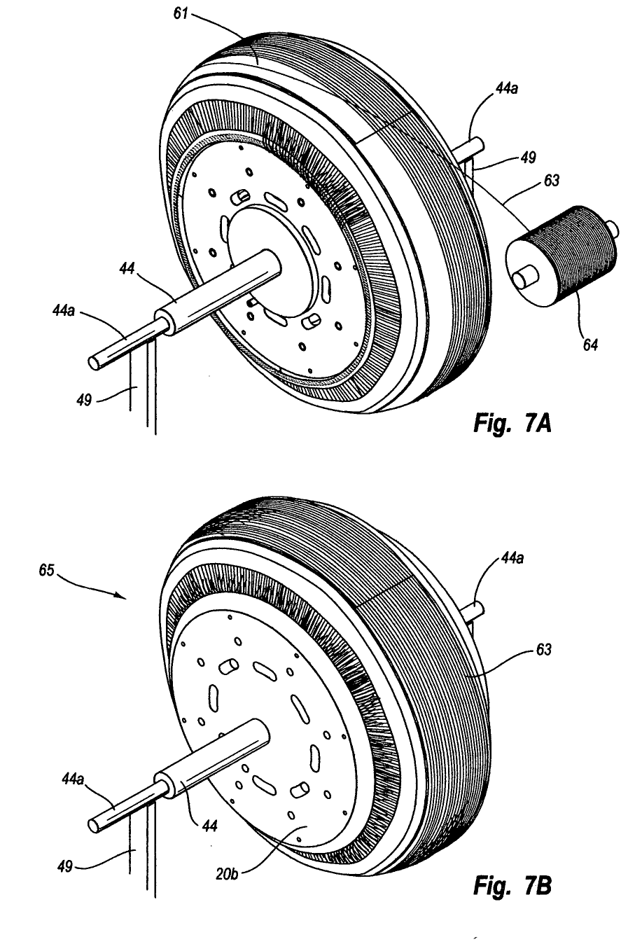

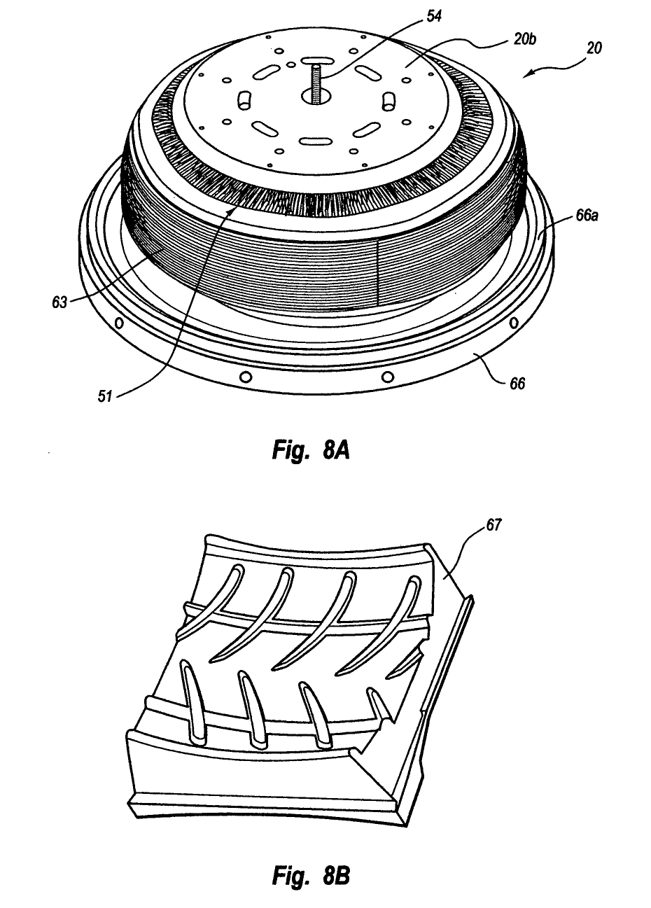

FIG. 6E shows the inner mold mounting plies 51 of FIG. 5C, that is aligned to receive the bead 55 encased in the pre-cured elastomer 56 that is maintained on a non-stick surface 60, such as wax paper, and is aligned to pass the left vertical post 49. Shown in FIG. 6F, the pre-cured elastomer covered bead 55 is guided by its passage along the bobbet plate 45 edge 45a onto plies 51, sticking thereto by the pre-cured elastomer 56, and extending up the plies cords. Thereafter, the plies loop ends are picked off the bobbet plate pins 47, are folded over the bead 55 and onto the pre-cured elastomer, encapsulating the bead in the plies and pre-cured elastomer. This picking off of the plies cord loop ends off of the bobbet plat pins 47 and folding the plies back upon themselves continues until the bead is fully encapsulated in the plies, as shown in FIG. 7A. Additionally, to maintain uniform plies adhesion to the ply side a cord may be passed through the plies cord loop ends and closed by joining the cord ends into a loop that is the circumference of the location along the plies that the ply ends will reach when folded upon themselves. Which cord maintains the plies together as they are folded, holding them in place.

FIG. 6E is also shown as having a stack of belts 60 attached across the circumference of the plies 55. The belts 60 in this embodiment are formed separately on a belt table, not shown, that is first covered with plastic that can be easily released from a formed belt or belt section. In which belt formation, a section or segments of woven belt material is laid over the table and cut into two eight inch wide belt sections that are laid out with a twenty four degree cord angle to the belt edges on the table. Tape is applied to the outside of the crossed belt sections or segments to maintain them together as a belt whose cords form a twenty four degree angle to what will be the belt circumference, and the tape and plastic are cut alongside the formed belt. So arranged, when the described ply winding is complete, and after layer of a separator, which is gauze material and is preferably cotton batting having approximately four layers and is wrapped around the plies circumference. Whereafter, the belt 60, as set out above, is fitted around the core on top of the separator. If additional belts are used, separators, that are also preferably sections of cotton batting, are fitted between the belts, with a top belt 60 shown in FIG. 6E. A final layer of cotton wrimple cloth 61, that is a cloth having closed spaced holes, or a separator formed from the cotton batting, is applied onto the belt 60, as shown in FIG. 6F, whereafter, as shown in FIG. 7A, the bobbet plates 45 are removed and a Kevlar cap 63 is applied as a cord wound around the circumference. Which Kevlar cord is shown as a roll 64 but, it should be understood, the cord as is used in practice is continuous for the entire wrapping process. FIG. 7B shows the finished Kevlar cap 63 around the crown and with the hub top 20b fitted thereover, completing this first embodiment of a process for forming the core 65 of plies, belts and beads formed on the inner mold that is ready now ready to receive the components of an outer mold 70, that is shown as a finished mold in FIG. 8D. While not shown, it should be understood that the finished mold contains gate plate section for directing liquid elastomer therethrough and is covered with the mold hub cap 20b.

To form the outer mold 70, the inner mold 19 mounting the core 65 is removed from its mounting on the vertical arms 49 of the build stand, the axle 44 is removed and replaced with a lifting rod 54 and the inner mold with the core 65 thereon is turned ninety degrees and positioned on the inner surface of a mold base 66, as shown in FIG. 8A. FIG. 8B shows a single thread segment 67 that is one of a number of like thread segments that are individually numbered and fitted, in numerical order, onto an upstanding lip 66a of the mold base 66, as shown in FIG. 8A, forming a cylinder. The tread segments 67 are shown in FIG. 8C fitted around the mold base plate 66 leaving the top open, exposing lifting rod 54 that extends upwardly from the core 65 open center. In practice eight tread segments 67 are used that are individually numbered from one to eight to fit onto a lip 66a at a location on the mold base plate 66 whereon the corresponding number one through eight is scribed. Shown in FIG. 8D, a mold cover plate 68 is installed onto the coupled tread segments 67 such that the lifting rod 54 fits through a cover plate center opening 69 that can receive a nut, not shown threaded thereon that attaches to a lifting device, such as a crane, not shown, to move the assembly to a casting well. In which casting well, with the lifting rod 54 removed, a flow of liquid elastomer is directed through the mold cover plate 68 center opening 69 as the mold is spun up to a speed of between 250 to 750 rpm, as indicated by arow A in FIG. 8d, causing the liquid elastomer to flow between and fill the inner and outer molds 19 and 70, encapsulating the core 65 in the tire, as shown in FIGS. 10 and 11, as described below.

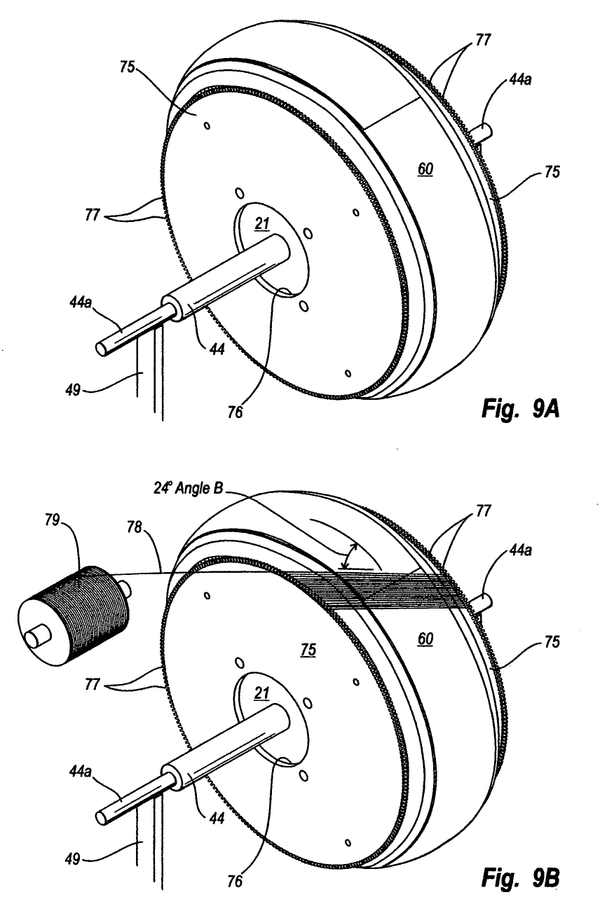

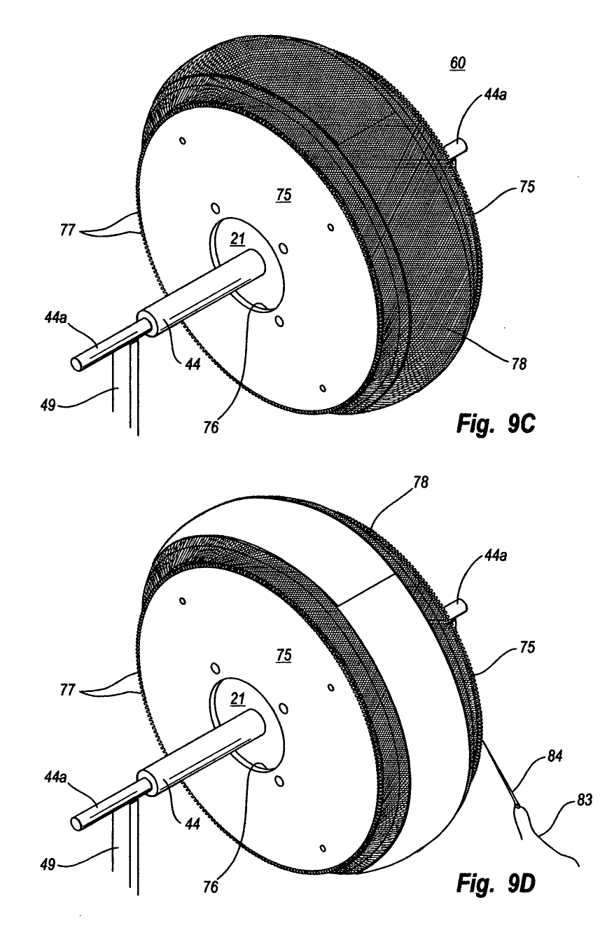

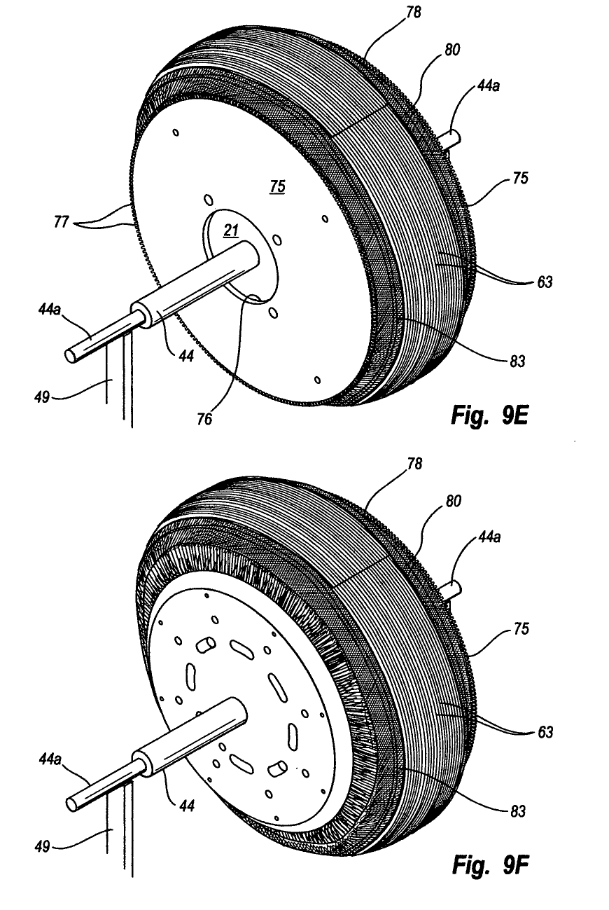

Shown in FIG. 9A is another embodiment of apparatus for practicing an alternative process for forming the belts 60 on the plies 51. Shown therein, with the plies woven fully over the inner mold 19, and after a spacer 50, that is preferably layer of cotton batting, is fitted and maintained around the inner mold circumference, and with the bobbet plates 51 mounting the plies loop ends on the bobbet plate pins 47, identical gear plates 75 each having an open center area 76 are slid along opposite ends of the axle 44, and attached to opposite sides of the inner mold. With the gear plates 75 open center areas 76 fitted over the inner mold hub center dish 21. The gear plates 75 have their teeth 77 aligned across the inner mold to receive belt cord 78 wound from a tooth on one side of the gear plate to a tooth on the other gear plate. With the teeth over which a winding of belt cord 78 is taken being off set from one another to where the wound cord with forms a twenty four degree angle B to a circumference of the inner core 19. A spool 79 is shown as having the belt cord 78 wound thereon that is preferably cotton or rayon cord. It should be understood that, while the spool 79 is shown, the cord rolled therefrom is continuous around and across the inner mold.

A first belt segment is wound, as shown in FIG. 9B, whereafter a second belt segment is wound over the first except that the second belt segment is wound over teeth that are selected to provide that the cords of the second belt segment slope oppositely to the cords of the first belt segment, with the cords of the first and second belt segments each forming approximately twenty four degree angles to the circumference of the inner mold. A first belt 60, shown in FIG. 9C, is thereby formed by the crossing belt segments that is essentially the same belt as that shown in FIG. 5C. Thereafter, as shown in FIG. 9D, a separator layer 81 is applied around the circumference of the inner core, above the first belt 60. Which separator layer 81 is porous to pass a flow of liquid elastomer therethrough, and is preferably like the section of cotton batting 50 as is used to separate the belt or belts from the plies, as shown in FIGS. 5A and 5B, and is preferably a four layer section of cotton batting having a width of approximately eight inches. A single belt 60 only, that has been formed as set out above, can be applied onto the plies 51, or a second and more belts 60 can be so formed, with each belt 60 having a separator layer 81 therebetween, and a final separator layer 81, as shown in FIG. 9D, is fitted over the belts. Whereafter, a final circumferential wrap of a Kevlar cord 63, as shown in FIG. 9E, is made around the circumference, by turning the inner mold and playing a Kevlar cord across the inner mold circumference, forming a Kevlar wrap 63 that is like that of FIG. 7A.

The separator layer 81 is folded back across the belt, exposing the belt loop ends maintained on the gear teeth 77. The belt loop ends are then individually picked off of the gear teeth and a cord, preferably a cotton or rayon cord, is threaded through the belt loop ends, as illustrated by the cord 83 and needle 84 of FIG. 9D, and is ended in a slip noose that the other cord end is fitted through. The gear plates 75 are then removed and the cord 63 is drawn through the slip noose, pulling the cord 83 loop ends down the tire, and is tied off, as shown in FIG. 9E. Like the embodiment of FIGS. 6E and 6F, with the belt or belts and separators in place, and with the Kevlar cord would around inner mold as a top thereto, the beads are fitted to the core sides, as shown in FIG. 6E, passing onto the plies cords, and over the mold hubs center dishes 21. Thereafter, as shown in FIG. 6F, the plies loop ends are picked off of the bobbet plates 45 pins 47 and bent across the bead and onto themselves, and into an adhesive, such as a pre-cured elastomer, bonding the plies to themselves, as illustrated in FIGS. 6F and 7A. Thereafter bobbet plates 45 are removed and the inner mold 19 mounting the core 65 is turned and moved onto the mold base 66, as shown in FIG. 8A as core 65. With the outer mold formed, as shown in FIGS. 8A through 8D, and moved to a casting well, liquid elastomer is passed therein as the mold is spun up, as set out above, forming a tire 90 like that shown in FIG. 11.

It should be understood that the invention is in the arrangement of a core 65 of plies, belts and beads formed for positioning in a mold to receive an elastomer spun cast or molded around the tire core 65 that is formed on the inner mold 19 within outer mold 70 forming, in a single casting operation, a tire 90, like that shown in FIG. 11. The elastomer constituents are preferably a liquid isocyanate and a liquid poly, respectively, that are selected to form, when they are combined and cured, an elastomer having a desired hardness or derometer for an automobile or like transport tire. The elastomer constituents are further selected to, when mixed, produce heat through an exothermic heat of reaction that is sufficient to cure a pre-cure elastomer, as described above.

The invention, as described in detail above, is in a formation of a tire core 65 on an inner mold where tire plies, belts and beads are positioned and maintained in a stable attitude for subsequent fitting and positioning into the outer mold that an elastomer is directed into, flowing around and encapsulating the core inner and outer surfaces and flowing around the tire plies, belts and beads, to bond to the cotton or rayon cords as the plies and belts are form from and for flowing through and bonding with the porous cotton batting spacers and Kevlar cords 63, forming a finished tire 90.

While preferred embodiments of our invention in a process and apparatus for forming a tire core and its use for the manufacture of a tire in a single molding operation, and the tire formed by a practice of the process in the apparatus, have been shown and described herein, it should be understood that variations and changes are possible to the process for the formation of the described tire core, and apparatus to form the tire core, and the tire as formed, and the materials used, without departing from the subject matter coming within the scope of the following claims, and a reasonable equivalency thereof, which claims we regard as our invention.

1. A process for manufacturing a tire core on an inner mold that receives an outer mold fitted thereover to receive an elastomeric material flow in a spin casting operation that fills the mold annular area and encapsulates the tire core, forming a tire comprising the steps of, assembling an inner mold that includes top and bottom hub plates with a hub therebetween having a center passage therethrough and aligned ports, and mounting truncated pie shaped hard foam core segments onto said hub to encircle said hub and have the shape of the interior of a tire and having an exterior surface to receive a core of plies, belts and beads built thereon; fitting an axle through said center passage and supporting ends of said axle on top ends of vertical members of a build stand; installing one of a pair of bobbet plates onto each side of said inner mold, which bobbet plates are round disks having a raised center area with a center hole therethrough and pins that are spaced equidistant from one another and extend outwardly and are arranged in a circle that is centered on the plate center and is between the center opening and the outer edge of the raised center area; applying a separator formed from a porous material to pass a flow of liquid elastomer therethrough around the circumference of said hard foam core, lacing a continuous ply cord, that is cotton or rayon cord, back and forth across said hard foam core between aligned bobbet plate pins, covering said foam core; applying a layer of porous spacing material over the plies, around said hard foam core circumference; applying at least one belt around said hard foam core circumference where said belt is formed from overlaid sections of woven cotton or rayon cords with said cords to each form an angle of approximately twenty four degrees to a line around said hard foam core circumference, with said belt segments cords sloping oppositely to cross at a center line around said hard core; applying a separator layer over said belt or belts that is formed from a section rayon or cotton material; winding a layer of tire cord around said section of material around said belt; fitting a bead coated with an adhesive along each side of said axle, crossing an outer edge of said bobbet plate raised center portion and onto the plies sides; picking off the plies loop ends off from the pins of said bobbet plates and folding each ply loop end across said bead and onto said ply side, completing the core of plies, belts and beads; removing said bobbet plates and installing the inner mold onto an outer mold disk shaped base plate and fitting tread segments side by side on said outer mold base, adjacent to its edge, forming a cylinder, and capping said cylinder with an outer mold disk shaped top plate that has a center opening therein, completing the outer mold containing the inner mold mounting the core of plies, belts and beads in an annular area between said inner and outer molds, providing a finished mold; and positioning said mold in a casting well and spinning said mold to between 250 and 750 rpm and passing a flow of liquid elastomeric material through the outer mold top plate center opening to fill the annular area and encapsulate the core of plies, belts and beads in a finished tire.

2. The process as recited in claim 1, wherein the hard foam core segments are pairs of top and bottom segments that have like aligned holes formed through their truncated bases that are fitted over rods that extend upwardly from the bottom hub plate.

3. The process as recited in claim 1, wherein the bobbet plates are passed along the ends of the axle to travel onto mounting rods that extend outwardly from the hub plates, providing registry of the bobbet plates with one another.

4. The process as recited in claim 3, wherein the inner mold mounted onto the axle is pivoted through ninety degrees and positioned on top ends of spaced vertical arms of the build cradle.

5. The process as recited in claim 4, wherein the porous spacing material is a belt of approximately four layers of cotton batting that is approximately eight inches in width and is secured as a continuous belt around the inner mold circumference.

6. The process as recited in claim 1, wherein the belt segments are cut from sections of a cotton or rayon weave to where the cloth individual cords are spaced apart and are on a bias to said segment edges, forming approximately a twenty four degree angle to the circumference, and are laid up to fit around the inner mold circumference, one section over the other with the slopes of the cords of the two segments sloping oppositely, crossing in the middle of the inner cord circumference, forming a belt.

7. The process as recited in claim 6, wherein a plurality of belts are fitted one over the other around the inner mold circumference covered by the plies, and a porous spacing material layer is positioned between each belt.

8. The process as recited in claim 7, further including applying a final porous spacing material layer on top of the top belt; and rotating the inner mold to wind a tire cord as a circumferential wrap over said final porous spacing material layer.

9. The process as recited in claim 1, further including installing gear plates having like teeth on their outer circumferences onto the sides of the top and bottom hub plates, with the gear teeth aligned, and lacing cotton or rayon cord between offset gear teeth around the inner mold circumference forming a first belt segment where the segment cord is at approximately a twenty four degree angle to the circumference, and lacing cotton or rayon cord between offset gear teeth around said mold circumference forming a second segment that overlays with the cords of said first segment and with the segment cords sloping oppositely, each at approximately a twenty four degree angle to the circumference, forming a belt.

10. The process as recited in claim 9, further including applying a porous spacing material layer over the belt and forming a second belt thereover that is covered with a final porous spacing material layer; and rotating said inner mold and winding a tire cord as a circumferential wrap over said final porous spacing material layer.

11. The process as recited in claim 10, further including folding the edges of the porous spacing material layer over the edges of the circumferential wrap, exposing the belt cord loop ends that are threaded by a cord that is looped on one end and receives the other end pulled therethrough, forming a loop that is drawn together to draw the belt loop ends down the plies, holding the belt loop ends in place over the plies.

12. Apparatus for forming a core of plies, belts and beads mounted in an annular area of a cavity mold to receive a flow of an elastomeric material passed therein for spin casting a tire comprising, an inner mold that includes top and bottom hub plates that are round disks and are alike except that said top hub plate has a center hole therethrough, and each said hub plate has a center area on the hub plate interior surface that has a dish shape on an inner face to accommodate a cylindrical hub fitted therein and has an external raised center area on its outer face that is to receive an open center area of a bobbet plate fitted thereover, and means for connecting said top and bottom hub plates to said cylindrical hub to align spaced holes, forming open passages therethrough to provide flow pathways to a flow of elastomeric material, and which said top and bottom hub plates include straight spaced studs with means for coupling each said stud end to each said top and bottom hub plate; pairs of top and bottom hard foam cores that fit together with like pairs to form a mandrel having a shape of a tire interior wall, and which hard foam cores have pie shapes with truncated bases wherethrough holes are formed to slide over one of the spaced studs; a pair of identical bobbet plates that are round disks with open center areas to fit over said hub plate raised center area and connect to said hub plate for maintaining said bobbet plate aligned with one another and said bobbet plates each have an outer circumference to closely pass a tire bead, and includes a circle of outwardly extending pins that are spaced equidistant from one another and are each at the end of a radial from the bobbet plate center that is less that a radial distance to said bobbet plate outer circumference; a pair of disk shaped top and bottom outer mold bases that are alike except that said top mold base has a center opening for passing a flow of liquid elastomeric material therethrough; and a plurality of tire tread segments for assembly onto said bottom outer mold base, forming a cylinder that is capped by said top outer mold base, as the outer mold containing the inner mold, with the core of plies, belts and beads formed on the inner mold in the annular space between said inner and outer molds.

13. The apparatus as recited in claim 12, further including a bead tray that is a formed as a disk having a large center opening that is of a diameter to fit over the outer edge of each of the top and bottom hub plate and includes a raised circular section adjacent to the center opening that is adjacent to an outer circular trough that slopes upwardly to the disk edge, and which said trough has a diameter to accommodate a tire bead fitted therein.

14. The apparatus as recited in claim 12, further including a pair of identical gear plates each having an open center arranged to fit over the hub plates center area, with gear teeth to approximately align with the circumference of the hard form cores; and means for mounting said gear plates onto the bobbet plates to maintain the alignment of the gear plates teeth.

15. The apparatus as recited in claim 12, wherein the hub and hub plates spaced holes are curved elliptical openings; and means for directing a flow of liquid elastomeric material passed in through the top mold base center opening into said curved elliptical openings.

16. The apparatus as recited in claim 12, further including a build cradle having spaced upright vertical arms whose ends receive and support ends of an axle fitted through the top and bottom hub plates center holes; and an axle with means for temporary mounting said axle through said top and bottom hub plates center holes.

17. The apparatus as recited in claim 12, wherein the tread segments interior surfaces each have a tread designed formed therein and are individually numbered from one to eight to correspond with numbers on the mold base that are located at spaced intervals around a mold base outer lip, that are assembled in numerical order between the mold base and top plates, forming a continuous interior outer wall that will mold a tread into the tire.

18. A tire formed by a practice of and with the apparatus of the invention formed from an elastomeric material utilizing inner and outer molds where a core of plies, belts and beads is built on the inner mold with the outer mold fitted thereto provide a mold within an annular cavity that the elastomeric material is directed into in a spin casting operation, encapsulating the core of plies belts and beads, forming a perfectly balanced tire comprising, a tire having side walls and a tread area; beads formed from an inelastic material positioned in the side walls lower ends; plies formed from cotton or rayon cords that extend across the tread area, pass around said beads and are folded upon themselves; a porous spacer that is located below the plies that is formed from a flexible material to pass a flow of elastomeric material therethrough and bond to which elastomeric material; a wrap of a multi-layer of cotton batting material is wound around circumference, over the plies tread area; belt segments formed from cotton or rayon cords are applied onto the wrap formed from a multi-layer of cotton batting material with the cords of the belt segments each forming an angle of approximately twenty four degrees to the circumference, and said belt segments are laid onto one another with the cords sloping oppositely, crossing at a line around the center of the circumference, forming a belt; a wrap of a multi-layer of cotton batting is wound around the belt; and tire cord is wound around the circumference, from one side to the other, covering the wrap of a multi-layer of cotton batting, as the top layer of the core below the tire tread.

19. The tire as recited in claim 18, wherein the belt segments are wound to have loop ends that receive a cord threaded therethrough, and with one threaded cord end tied into a loop and the other threaded cord end fitted through said loop, the threaded cord is pulled tight to cinch the belt segment down the sides of the plies.

20. The tire as recited in claim 18, wherein a plurality of belts are fitted around the circumference, on top of one another, with a wrap of a multi-layer of cotton batting positioned between each belt.

21. The tire as recited in claim 18, wherein the porous spacer and the wrap are a four layer section of cotton batting.
